(19) United States
(12) Patent Application Publication
(10) Pub. No.: US 2011/0245939 A1
(43) Pub. Date: Oct. 6, 2011

(54) APPARATUS, METHOD, AND SYSTEM FOR DEMONSTRATING CUSTOMER-DEFINED LIGHTING SPECIFICATIONS AND EVALUATING PERMANENT LIGHTING SYSTEMS THEREFROM

(75) Inventors: JOE P. CROOKHAM, OSKALOOSA, IA (US); JEFFREY A. ROGERS, OSKALOOSA, IA (US)

(73) Assignee: MUSCO CORPORATION, OSKALOOSA, IA (US)

(21) Appl. No.: 13/075,790

(22) Filed: Mar. 30, 2011

Related U.S. Application Data
(60) Provisional application No. 61/319,103, filed on Mar. 30, 2010.

(51) Int. Cl. G06F 17/00

(52) U.S. Cl. 700/90

(57) ABSTRACT

Envisioned are apparatus, methods, and systems whereby a customer and an initial provider work cooperatively to develop quantifiable lighting specifications for the customer's application. Said specifications are developed as a result of the customer's feedback to a lighting demonstration. The developed lighting specifications may then be used by the customer in evaluating potential lighting suppliers (which may include the initial provider) to ensure the desired lighting scheme can be duplicated by a permanent lighting system.

### CROSS-REFERENCE TO RELATED APPLICATIONS

This application claims priority under 35 U.S.C. §119 to provisional U.S. application Ser. No. 61/319,103, filed Mar. 30, 2010, hereby incorporated by reference in its entirety.

### I. BACKGROUND OF THE INVENTION

The present invention generally relates to systems, apparatus, and methods of defining lighting needs for an application in a way that is understandable to both a customer and potential lighting suppliers. One relevant lighting application is large area lighting. A few examples are sports fields, parking lots, roadways, large event sites, and the like. But the invention can be applied in analogous ways to other applications including interior lighting. More specifically, the present invention relates to the demonstration of lighting schemes, the development of a quantifiable lighting specification based on customer response(s) to the demonstration, and the development of a permanent lighting system based on customer selection of a lighting supplier that demonstrates an ability to reproduce a lighting scheme based on the developed lighting specification.

In the current state of the art, there are a variety of tools and methods available to lighting designers to define a lighting fixture, the projected light thereof, and the effect of the projected light on a target area. Terms which define a lighting scheme (e.g., color temperature, operating wattage, field angle, luminous efficacy, coefficient of utilization), while well understood by those in the field of lighting, are rarely understood by a typical customer. There is a disconnect between customers and lighting designers which, in the current state of the art, is bridged by such things as lighting scans (also referred to as lighting summaries or point scans) which show photometric data overlaid on a scaled model of the target area, or by site tours which allow a customer to see lighting fixtures illuminating an area similar to but not at the actual target area. Both of these approaches have disadvantages; a customer may not be familiar with photometric data and a site tour may be misleading if the lighting scheme at a test site cannot be reproduced at the customer's site.

Often, customers are not able to clearly define what it is they want illuminated or in what fashion, but are able to clearly define what they want changed when presented with a visual demonstration. For example, if presented with a lighting scan a customer may not be able to identify inadequacies in the lighting scheme or correlate what is on paper to a mental image; but if presented with an actual lighting demonstration at the target area, a customer may be able to provide feedback (e.g., too dark in this corner, the light is too yellow) to facilitate changes that will result in a lighting scheme that suits the customer's needs or preferences.

As another example, when on a site tour a customer may think what is observed is reproducible at his/her own target area, which may not be the case (e.g., a light source of similar color temperature is not available for the customer's application in the wattage needed, ambient light at the tour site is not available at the customer's site, etc.). Changes in topography, for example, at the customer's site may drastically change the look of a lighting scheme at and on a target area and customers, having purchased a lighting system based on what they saw on a site tour, may have little recourse.

In the current state of the art, customers lack the tools to provide valuable feedback for lighting specifications for an application, and often must rely on esoteric data from lighting designers to make an informed decision. Thus, there is room for improvement in the art.

### II. SUMMARY OF THE INVENTION

It is generally impractical to teach every customer how to interpret photometric data, to discuss every way in which the lighting at a site tour may differ from lighting at the customer's target area, or to understand all field-related terminology. Likewise, it is generally impractical to require lighting designers to define a lighting scheme without quantifiable parameters such as photometric data; lighting designers often have to verify conformity to lighting codes/standards and have some way of defining the quality of their product.

To satisfy the needs of both lighting designer and customer and to bridge the communication gap, envisioned are systems, apparatus, and methods whereby a customer may visualize a lighting scheme, provide feedback, and visually ascertain how said feedback affects the lighting scheme. In this fashion, a customer may work cooperatively with a lighting provider to produce a customized lighting scheme that (i) makes tangible the needs of the customer and (ii) is useful in developing quantifiable lighting specifications.

It is therefore a principle object, feature, advantage, or aspect of the present invention to improve over the state of the art and/or address problems, issues, or deficiencies in the art.

Further objects, features, advantages, or aspects of the present invention may include using said quantifiable lighting specifications to evaluate proposals for permanent lighting systems from one or more potential suppliers.

One method according to aspects of the present invention comprises evaluating an initial definition of lighting needs, selecting a suitable lighting system for demonstrating one or more lighting schemes based (at least in part) on the evaluation of the initial definition of lighting needs, demonstrating a lighting scheme (also referred to herein as lighting solutions), evaluating the lighting scheme, adjusting the lighting system, demonstrating a second lighting scheme, and so on until a desired lighting scheme is achieved.

These and other objects, features, advantages, or aspects of the present invention will become more apparent with reference to the accompanying specification.

### III. BRIEF DESCRIPTION OF THE DRAWINGS

From time-to-time in this description reference will be taken to the drawings which are identified by figure number and are summarized below.

FIG. 1 illustrates, in flowchart form, the relationship between the customer, a provider of a lighting demonstration, and potential lighting suppliers of a permanent lighting system.

FIG. 2 illustrates one possible example of a temporary lighting demonstration system.

FIG. 3 illustrates one possible website or software program user interface for creating quantifiable lighting specifications.

FIG. 4 illustrates one possible format for the lighting specifications based on input from the user interface of FIG. 3.

FIGS. 5A and 5B illustrate one possible adjustable light fixture that could be used to demonstrate lighting according to Embodiment 1.

FIG. 6 is an enlarged view of an exemplary control panel for demonstrate lights for Embodiment 1.

FIG. 7 is a perspective view of a portable computer and interface that could be used with Embodiment 1.

FIGS. 8A-8E are various computer screen interfaces that could be used with a rendering of lighting as Embodiment 4.

FIGS. 9A-C are various views of a rendering of demonstrated lighting according to Embodiment 4.

### IV. DETAILED DESCRIPTION OF EXEMPLARY EMBODIMENTS

### A. Overview

To further an understanding of the present invention, specific exemplary embodiments according to the present invention will be described in detail. Frequent mention will be made in this description to the drawings. Reference numbers will be used to indicate certain parts in the drawings. The same reference numbers will be used to indicate the same parts throughout the drawings.

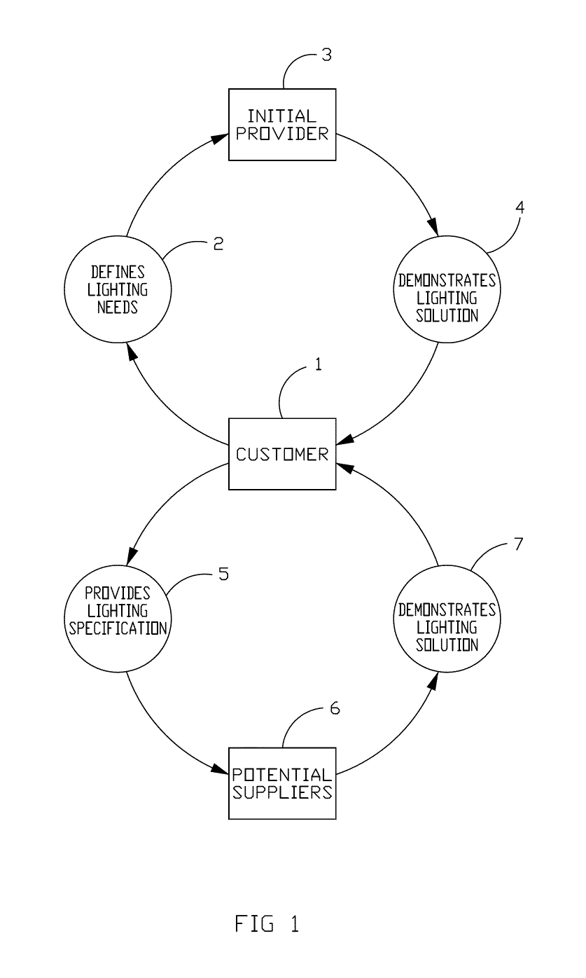

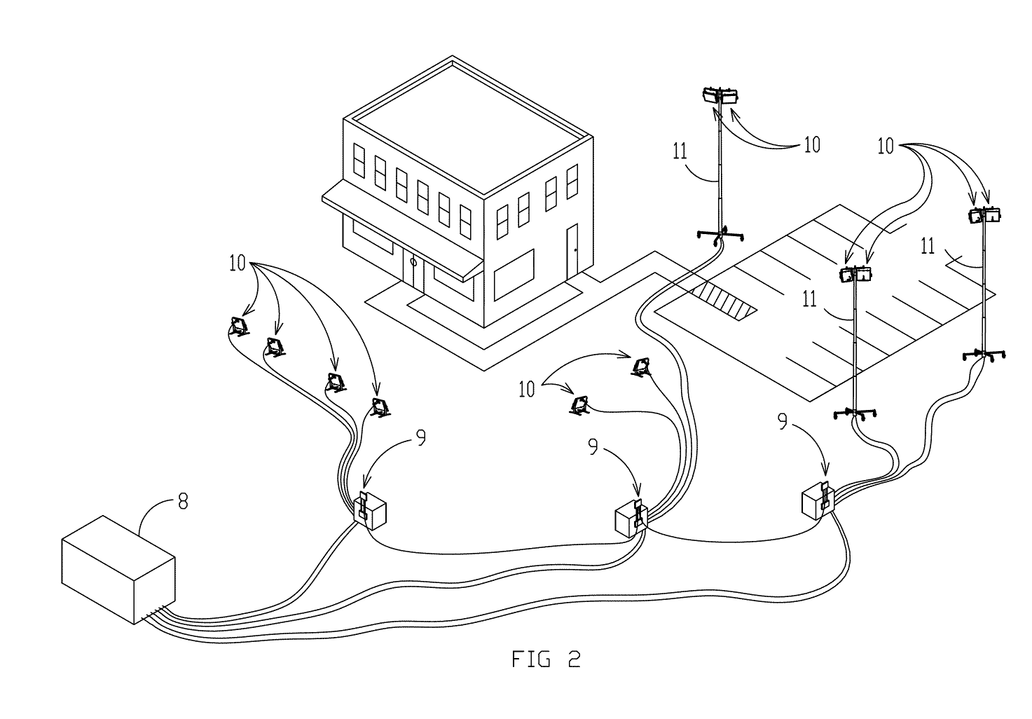

The present invention relates to the relationship between a customer and the lighting community, and ways in which the needs of a customer are transformed into a tangible product. In the context of this application, a customer (see FIG. 1, reference no. 1) may encompass end user(s) of a permanent lighting system, owner(s) of a site (or simply a target area at the site), a board of directors which regulate use of a site or target area, or any other person(s) which is/are responsible for purchasing equipment or making decisions regarding how to illuminate a target area. Likewise, any reference to an initial provider (see FIG. 1, reference no. 3) may encompass a lighting manufacturer, a lighting supplier, a lighting designer, or any other person(s) capable of demonstrating a lighting scheme. Still further, any reference to potential suppliers (see FIG. 1, reference no. 6) may encompass a lighting manufacturer, a lighting supplier, a lighting designer or any person(s) capable of providing or procuring a permanent lighting system. It is of note that the permanency of the lighting system selected by the customer is relative. For example, if the customer wants to light a temporary construction site, the decided upon “permanent” lighting system may have a shortened lifespan when compared to, for example, the decided upon “permanent” lighting system for a football field; the methods described herein would apply to both cases equally, as well as others in analogous ways.

An overview of the envisioned process is illustrated in FIG. 1. As can be seen from FIG. 1, at the center of the process is a customer 1. By way of example and not by way of limitation, assume customer 1 wants to illuminate a building, a parking lot, and the walkway between the two. As has been stated, in the current state of the art lighting suppliers may present customer 1 with photometric data of a proposed lighting solution (which may not be well understood by customer 1) or may take customer 1 on a site tour of a similar area (which may be misleading).

As envisioned in one or more embodiments, customer 1 supplies an initial provider 3 with a perceived definition of lighting needs; alternatively, provider 3 could develop a perceived definition of lighting needs based on interaction with customer 1 or otherwise. By perceived definition, it is meant a preliminary idea, sometimes incomplete, sometimes more subjective or qualitative than quantitative, of what lighting should accomplish at the target area for a given specification. It may contain all or most of typically quantitative estimates (e.g., color, temperature, light intensity and uniformity, luminous efficacy, coefficient of utilization or it contain just some of those quantitative estimates, or none. It could merely express a subjective idea of what the lighting should look like. Based on the perceived definition of needs, along with any other factors (e.g., availability of equipment), provider 3 selects a lighting demonstration system and demonstrates (ref no. 4) one or more lighting schemes at the target area (i.e., the area containing the building, parking lot, and walkway between the two) for customer 1 and/or other interested person(s). In this manner, customer 1 is able to evaluate different lighting schemes at the actual target area, and moreover, gain an understanding of how the aesthetic of a lighting scheme changes with changes to the lighting demonstration. As an example, provider 3 could install a diffusion sheet (well-known in the art) in the lighting demonstration system; the result may be a change in beam angle, but the customer's perception may be a “softer” light. As another benefit, by demonstrating various lighting schemes at the actual target area, customer 1 may evaluate the effect of the lighting scheme on adjacent areas, recognize potential glare and spill light concerns, or visualize mounting locations for permanent lighting fixtures.

According to aspects of the present invention, customer 1 may then evaluate the proposed lighting solution and redefine perceived lighting needs 2. For example, provider 3 illuminates the target area according to an initial definition of needs by customer 1, customer 1 sees that his/her initial definition causes the parking lot to be too dim or the building to be cast in an unflattering color, and redefines his/her lighting needs 2. In this manner, provider 3 is able to take direction from customer 1 and customer 1 is able to communicate needs in a manner that is understandable to both parties.

The result of this collaborative process is the development of a lighting scheme acceptable to customer 1 which can be fully characterized and documented by provider 3. There are a variety of ways provider 3 may characterize and document the approved lighting scheme; these may include those already known in the art of lighting design, those already described, or other ways. For example, once a lighting scheme is agreed upon, provider 3 may document the location and identifying information for each light source (e.g., type of light source, aiming angle, color temperature), take photometric data at various points on the target area, and provide customer 1 with a document which details information regarding the light sources used, a map of the target area, and a listing of quantitative photometric data (e.g., including where and in what manner photometric data was measured) with respect to the map of the target area.

Customer 1 may then use this document as instruction (see reference no. 5) to potential suppliers 6 as to what must be achieved by a permanent lighting system; document, in this sense, could be defined as a physical document, an electronic document, or the like. Potential suppliers 6 may then attempt to demonstrate (see reference no. 7) they can produce the desired lighting scheme—if customer 1 so chooses to impose such a requirement. Each potential supplier 6 may try to produce the desired lighting scheme using different equipment or different methods than initial provider 3 according to need, capability, desire, and the like. After appropriate evaluation, customer 1 may purchase a permanent lighting system and, if desired, have an independent lighting group evaluate the permanent lighting system after installation to ensure conformance to the developed lighting specification.

Thus, according to aspects of the present invention, customer 1 is able to describe his/her lighting needs to every potential supplier 6 via the developed lighting specification, and potential suppliers 6 have clear instruction for designing a permanent system. Further, customer 1 has the assurance that, after evaluating demonstrated lighting solutions 7 from potential suppliers 6, the result is a permanent lighting system that precisely addresses his/her needs; in short, what the customer wants in a lighting system is what the customer gets. Of course, customer 1 need not purchase a lighting system to adequately practice the invention as described herein.

### B. Exemplary Method and Apparatus Embodiment 1

A more specific exemplary embodiment, utilizing aspects of the generalized example described above, will now be described. According to a first embodiment and with respect to FIG. 1, provider 3 demonstrates a lighting solution 4 with a temporary lighting system such as that illustrated in FIG. 2 and discussed in U.S. patent application Ser. No. 12/604,572, incorporated by reference herein. As can be seen in FIG. 2, a power providing device 8 (e.g., portable generator) provides power to controllable lighting units 9 which facilitate the operation of lighting fixtures 10. Lighting fixtures 10 may house any manner of light source (e.g., LED, HID, incandescent), may be adjustable about multiple axes, may have adjustable optical properties (e.g., via color gels and/or diffusion sheets), may be adjustable in intensity, may be placed in a variety of operating positions (e.g., at ground level, on poles 11, affixed to the building), and/or may be adjustable in other manners so to provide multiple options which provider 3 may demonstrate and customer 1 may evaluate. The exact complement of adjustable features of the lighting system depends on the initial definition of lighting needs (see FIG. 1, reference no. 2); other temporary lighting demonstration systems and/or components are possible, and envisioned. Details of one such adjustable portable, temporary system can be seen at Ser. No. 12/604,572. Others are possible.

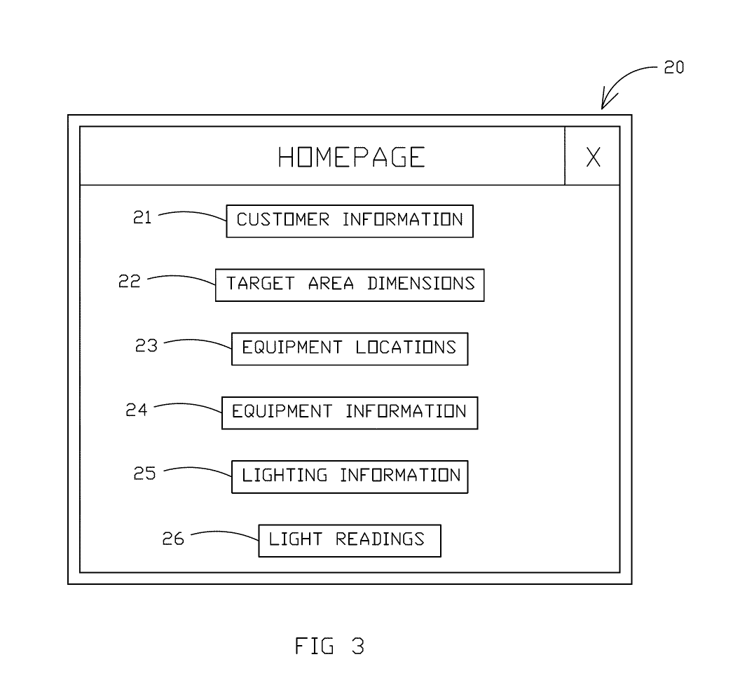

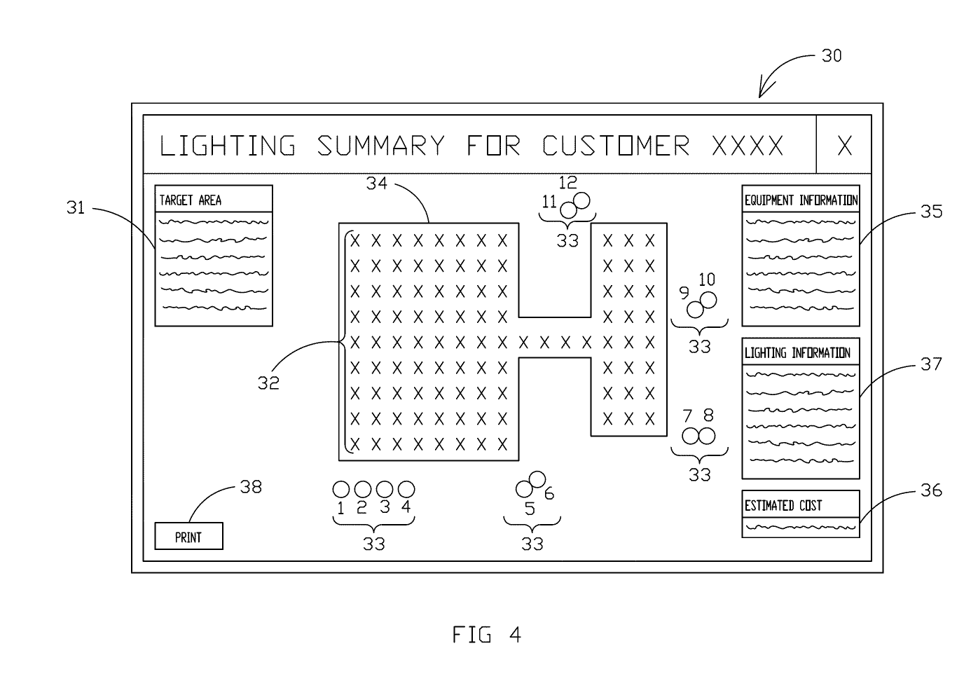

Once a lighting scheme is decided upon by customer 1, provider 3 may record the preferences in a computer or similar device via a user interface such as that illustrated in FIG. 3. As can be seen from FIG. 3, a web page 20 (or analogous application depending on the platform used) has various input options for provider 3. For example, provider 3 may access a customer information tab 21 (e.g., selectable by moving a cursor to screen tab 21 and clicking or selecting it) to record such things as contact information, target area location, etc. (e.g., can be entered via a computer keyboard or other data entry method). Provider 3 may access a target area dimensions tab 22 to enter or record the measured dimensions of the building, parking lot, and walkway. Provider 3 may access an equipment locations tab 23 to enter or record such things as how many lighting fixtures were used, how high lighting fixtures were suspended, etc. Provider 3 may access an equipment information tab 24 to enter or record such things as manufacturer information for equipment, number and type of fixture inserts used, etc. Provider 3 may access a lighting information tab 25 to enter or record such things as color temperature, rated lamp life, type of lamp, etc.

Provider 3 may also access a light readings tab 26 to enter or record light measurements, their locations on the target area, and make note of any conditions which might impact light measurements (e.g., overcast day, spill light from an adjacent property, etc.). Light measurements may be determined by a light meter (or analogous device) in a variety of fashions; U.S. Pat. No. 6,016,389, incorporated by reference herein, discusses different methods of measuring light at a target area. For example, a light meter held horizontally may be used to measure illumination in term of foot-candles at the center of 20′×20′ grids. In this example, provider 3 may use the information recorded for target area dimensions tab 22 to determine a number of grids which characterize the target area, giving each grid a unique identifier. Provider 3 may then measure light at the center of each grid and record the measurement—with its corresponding grid identifier—by accessing light readings tab 26. Having such lighting measurements allows provider 3 to calculate parameters often used in lighting design (e.g., max/min foot-candles). Other ways of measuring light are possible, and envisioned. Also, other or additional steps or information can be obtained and recorded.

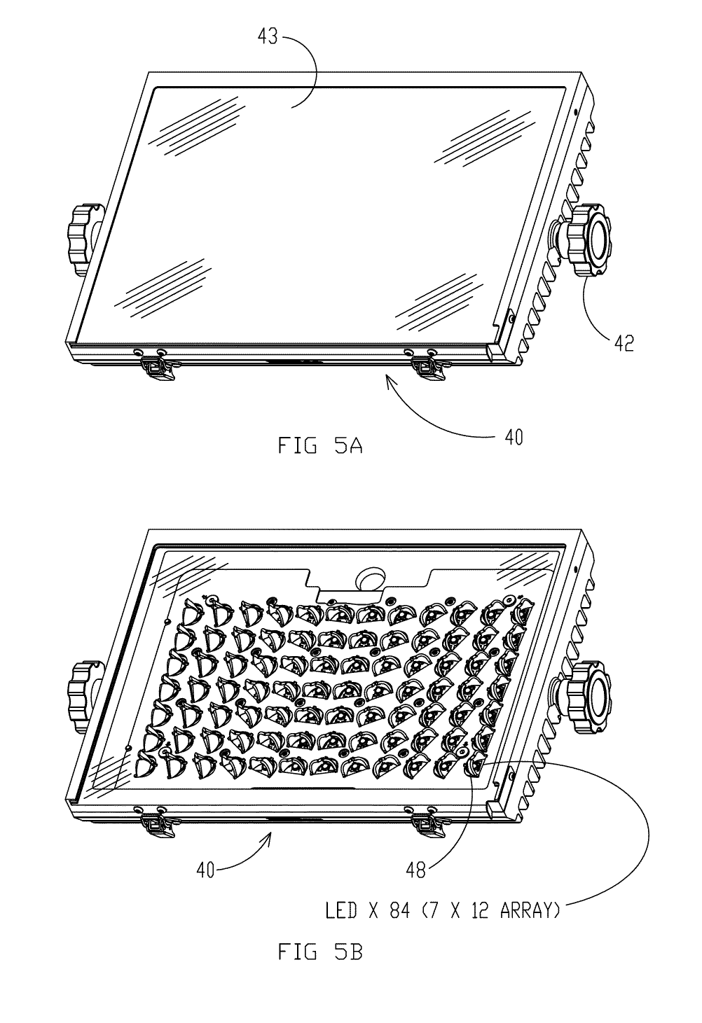

The information gathered and input into user interface 20 is compiled and used to produce a lighting summary; one possible example is illustrated in FIG. 4 in the form of web page 30. As can be seen from FIG. 4, a diagram of target area 34, equipment locations 33, and light reading locations 32 diagrammatically summarize information input into interface 20 useful for potential lighting suppliers 6 (FIG. 1). Conventional computer programming can accomplish this. Diagrammatic information is supplemented with information fields such as target area 31, equipment information 35, and lighting information 37 that correlate with individual equipment locations (e.g., fixture 12's position relative to the target area may be diagrammatically illustrated and technical information regarding fixture 12 listed under the appropriate heading in equipment information field 35 and lighting information field 37). Optionally, an estimated cost data field 36 may be included which calculates or estimates such things as operating cost based on consumed power and local power rates, principal cost based on a permanent installation of the selected demonstration system, etc. A print tab 38, when selected, allows provider 3 to export or print a copy of web page 30 for use by customer 1.

It is of note that, if desired, certain fields (namely equipment locations 33, equipment information 35, and estimated cost 36) may be omitted from the printout of summary page 30; this may be desirable if initial provider 3 wants to be considered for the permanent lighting system or wishes to keep certain product features secret from potential lighting suppliers 6. In this example, the printout provided to customer 1 still contains all the information (e.g., foot-candle readings 37, diagrammatic representation of grids 32, information regarding the target area 31) necessary for potential suppliers 6 to develop a permanent lighting system.

Equipped with printout of summary 30 (which may be an abbreviated form of that illustrated in FIG. 4), customer 1 is able to supply potential lighting suppliers 6 with an easily understood description of his/her/its lighting needs for a specific target area (i.e., a customer-defined lighting specification); see reference no. 5 of FIG. 1. In turn, potential lighting suppliers 6 may then demonstrate, according to their own capability and equipment, an ability to produce the same lighting scheme (see reference no. 7) by a visual demonstration at the target area, or by some other manner deemed acceptable by customer 1.

FIGS. 5A-B, 6 and 7 illustrate examples of components that could be used in Embodiment 1. One example of an adjustable light fixture 40 is shown in FIGS. 5A and 5B (see also Ser. No. 12/604,572). Plural LED sources each have individually amiable optics 48 and are mounted in a housing that can be aimed in different orientations. FIG. 5A shows fixture 40 assembled with lens 43. FIG. 5B shows fixture 40 with lens 43 removed. Fixture 40 can be modified to create different lighting outputs and effects, or different fixtures 40 could be substituted to create different outputs and effects individually and compositely. Of course, other fixtures can be used and adjusted.

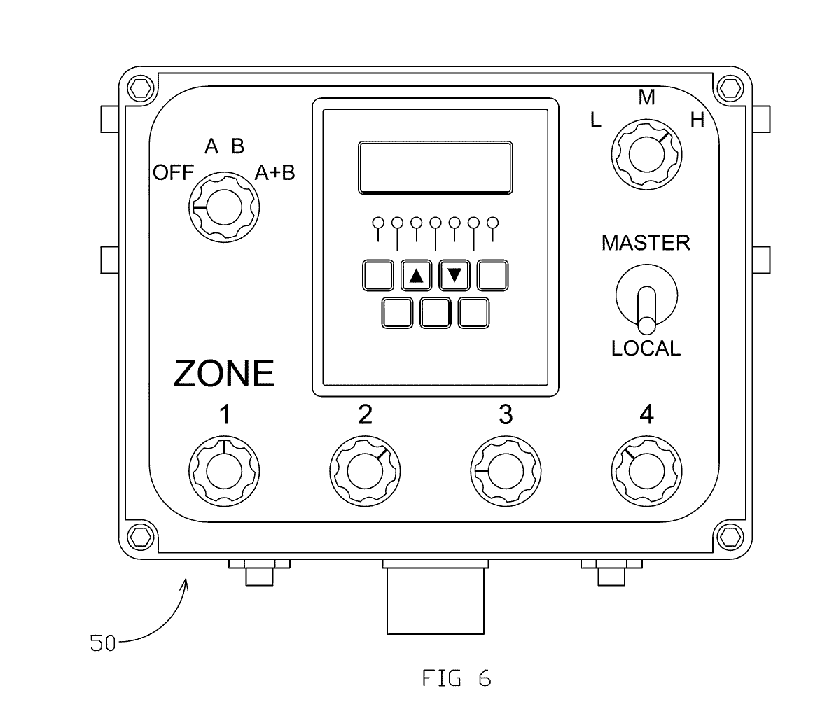

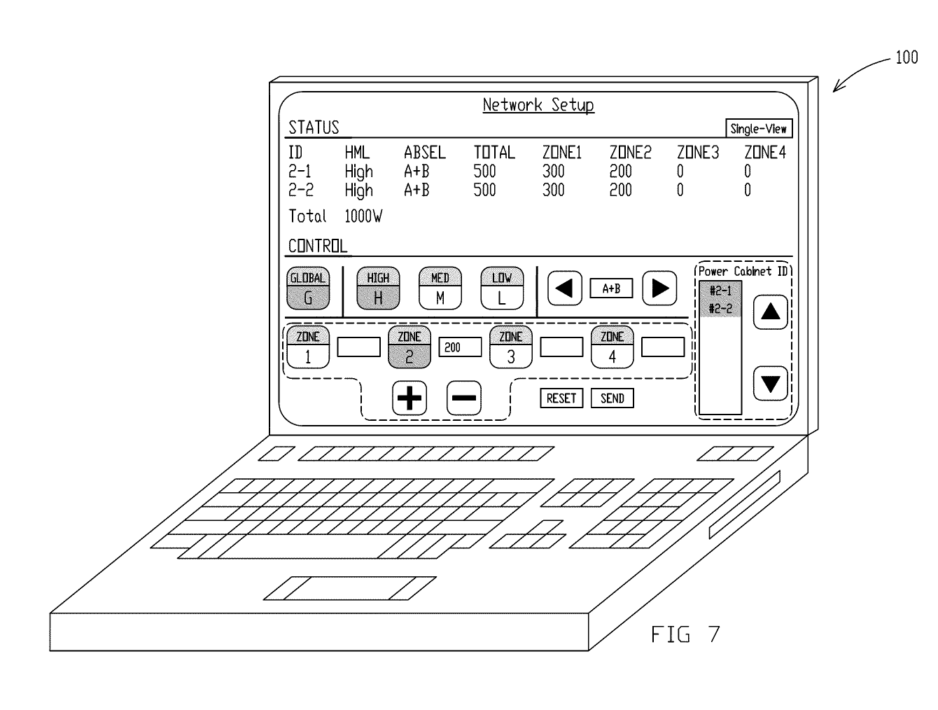

FIGS. 6 and 7 illustrate examples of other components that could be used with Embodiment 1. A lighting control panel 50 (FIG. 6) could allow an operator to turn fixtures 40 off and on, the add or subtracts electrical power to get different light intensity (L=low, M=medium, H=high), and the like. The control could also be manual. Laptop computer 100 (FIG. 7) could monitor and record the status of the fixtures and/or control panel 50, display information, or itself be a control panel. Other control and documentation systems can be used. Specific configurations are within the skill of those skilled in the art.

### C. Exemplary Method and Apparatus Embodiment 2

According to a second embodiment and with respect to FIG. 1, provider 3 demonstrates a lighting solution 4 (FIG. 1) with permanent light fixtures that are made to be portable. As one example, permanent lighting fixtures may be supported by a temporary portable base, such as is described in U.S. Pat. No. 5,944,413, incorporated by reference herein. Alternatively, permanent lighting fixtures may be transported to the target area and supported by a vehicle (or analogous device), such as is described in U.S. Pat. No. 5,313,378, incorporated by reference herein.

The demonstration of a lighting solution 4 and subsequent evaluation by customer 1, including revisions of defined lighting needs 2 can be as described in Exemplary Method and Apparatus Embodiment 1. As described in Exemplary Method and Apparatus Embodiment 1, this results in customer 1 defining a lighting specification which is provided to potential lighting suppliers 6 (see reference no. 5), potential lighting suppliers 6 demonstrating lighting solutions 7, and customer 1 evaluating proposed solutions.

One benefit of demonstrating a lighting solution with permanent lighting fixtures is that customer 1 knows what the final product will look like. This may be beneficial in that it may open a dialogue for further product customization whether or not directly related to characteristics of the light produced by the fixtures at the target (e.g., customer 1 may specify that the permanent lighting fixtures be painted a certain color for aesthetic purposes).

### D. Exemplary Method and Apparatus Embodiment 3

According to a third embodiment and with respect to FIG. 1, provider 3 demonstrates a lighting solution 4 with a scale model lighting system. In this embodiment it may be unfeasible or otherwise undesirable to illuminate the actual target area or some portion thereof, so provider 3 may perform the initial lighting demonstrations in a lab (or analogous area). Otherwise, the initial lighting demonstration may be performed using the scale model lighting system at the target area.

Assume, by way of example and not by way of limitation, provider 3 has a standard size lighting system like that described in aforementioned U.S. patent application Ser. No. 12/604,572 (FIG. 2). Provider 3 may determine the dimensions of the target area beforehand to determine an appropriate scaling factor. For example, assume the target area measures 60,000 ft². Provider 3 determines a 1/10^{th} scaling factor is acceptable and sets up the scaled lighting system about a 6,000 ft² area. The scaled lighting fixtures are 1/10 the size of the standard fixtures; as described in U.S. patent application Ser. No. 12/604,572 each fixture measures approximately 12″×16″×3″ and contains 84 LEDs. Thus, each scaled fixture measures approximately 1.2″×1.6″×0.3″ and contains approximately 8 LEDs. The optical characteristics (e.g., light output, beam shape) of the scaled lighting system are equivalent or at least analogous to that of the standard lighting system so that when customer 1 provides feedback and determines an acceptable lighting scheme, provider 3 can produce documentation which confirms the lighting scheme can be reproduced with the standard sized lighting system (e.g., if provider 3 wishes to be considered for the permanent lighting system). Of course, depending on the capabilities of provider 3, there may be limitations to what scaling factor can be used (e.g., 8 LEDs may not fit in the 1.2″×1.6″×0.3″ fixture, it may not be possible to produce a 1.2″×1.6″×0.3″ fixture, etc.).

The demonstration of a lighting solution 4 and subsequent evaluation by customer 1, including revisions of defined lighting needs 2 can be as described in Exemplary Method and Apparatus Embodiment 1. After customer 1 decides upon a lighting scheme, provider 3 may access web page 20 as in Exemplary Method and Apparatus 1 and input information with respect to the actual target area and standard sized lighting fixtures. Alternatively, provider 3 may input information with respect to the scaled target area and scaled lighting system and rely upon a computative method (e.g., modeling software, logarithm, etc.) to characterize the full scale lighting scheme; either method yields web page printout 30. As in Exemplary Method and Apparatus Embodiment 1, customer 1 may then provide the lighting specification to potential lighting suppliers 6 (see reference no. 5), potential lighting suppliers 6 may demonstrate lighting solutions 7, and customer 1 may evaluate said lighting solutions.

It is of note that a scaled lighting system may not be possible for all types of light sources. For example, with high intensity discharge lamps, the size of the arc tube, lamp envelope, and socket must all be reduced in size and without altering the optical properties; this may not be possible. However, for lighting systems that are scalable, one benefit to demonstrating a lighting solution with a scale model lighting system is that provider 3 may demonstrate various lighting schemes without significant cost (e.g., due to power consumption of a standard size lighting system, shipping of large parts to the target area, etc.) or potential damage to the actual target area.

### E. Exemplary Method and Apparatus Embodiment 4

According to a fourth embodiment and with respect to FIG. 1, provider 3 demonstrates a lighting solution 4 with a rendering (e.g., computer model) of the target area when illuminated. An example is described in U.S. Ser. No. 61/402,600, incorporated by reference herein.

In this embodiment provider 3 determines physical characteristics of the target area (e.g., by visiting the target area, by aerial photo) and inputs the information into, by way of example and not by way of limitation, a computer modeling program. This allows provider 3 to visually render the target area in a “before” state; provider 3 may also characterize the target area photometrically (e.g., via light meter measurements) and input said data into the computer modeling program to provide a more accurate representation of the target area in the before state. Customer 1 may then meet with provider 3 and supply an initial definition of lighting needs 2; alternatively, provider 3 could develop an initial definition of lighting needs independently. Having this information, provider 3 may browse through lighting system components indexed in the computer modeling program and place virtual representations of lighting system components about the rendered target area. Previously recorded photometric data for each lighting system component is used in combination with the placement of said lighting components by the computer modeling program to render an “after” image of the target area (see reference no. 4). In this manner, customer 1 may redefine lighting needs 2 and evaluate the result, while at any time referring back to the before image of the target area.

Once a lighting scheme is decided upon by customer 1, provider 3 may export information from the computer modeling program into a lighting summary (see, for example, FIG. 4) or analogous document. Customer 1 may then provide the lighting specification 5 (i.e., the printed lighting summary or analogous document) to potential lighting suppliers 6 and evaluate suppliers' demonstrated lighting solutions 7 as described in Exemplary Method and Apparatus Embodiment 1.

One benefit of demonstrating a lighting solution with a rendering of the target area is that customer 1 may always refer back to what the target area initially looked like; with an actual lighting system, this may be time consuming if provider 3 has to turn off multiple fixtures and then turn them all back on (and in some cases, wait for the lamps to warm up). Further, seeing a visual representation of lighting fixture components placed about the rendered target area may allow customer 1 to gain an understanding of what a permanent lighting system might look like when installed, and to propose changes which may be readily effectuated with little cost and no damage to the actual target area.

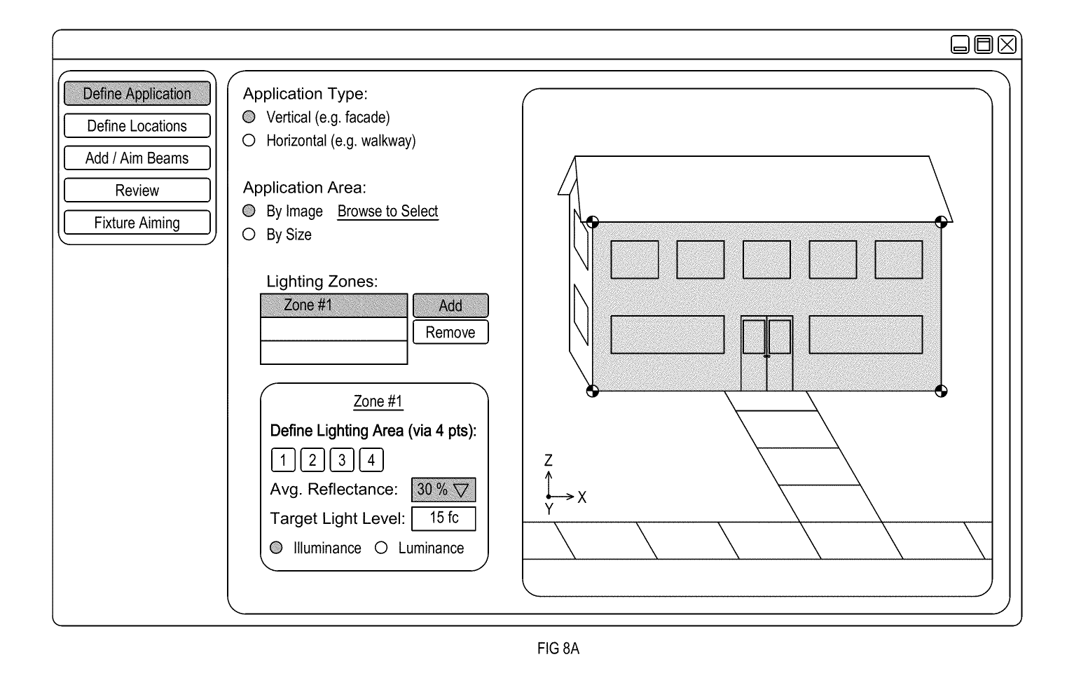

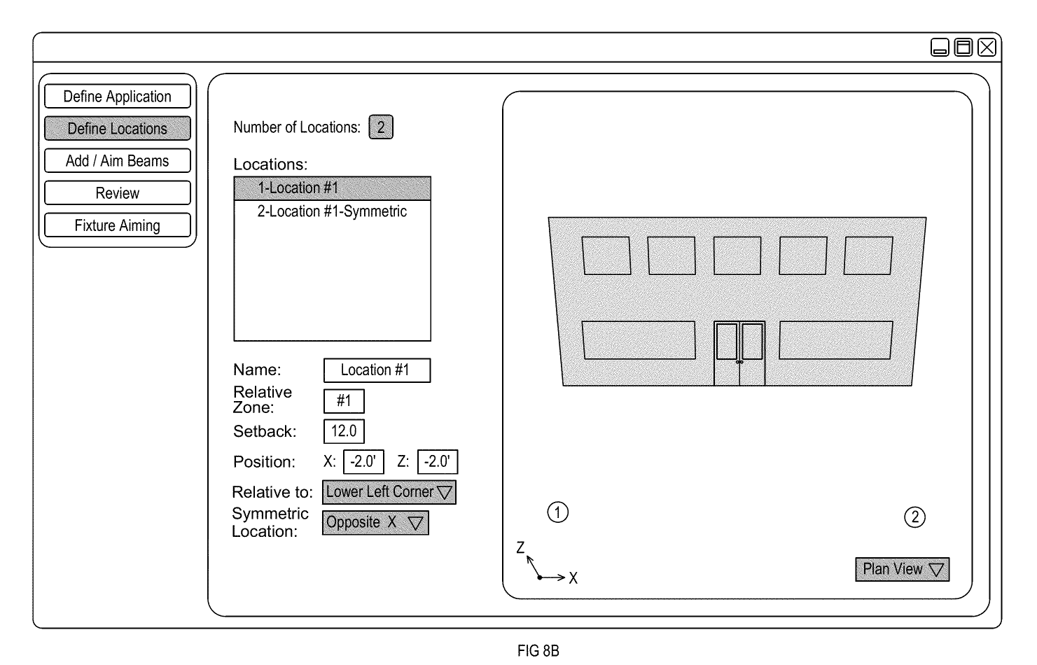

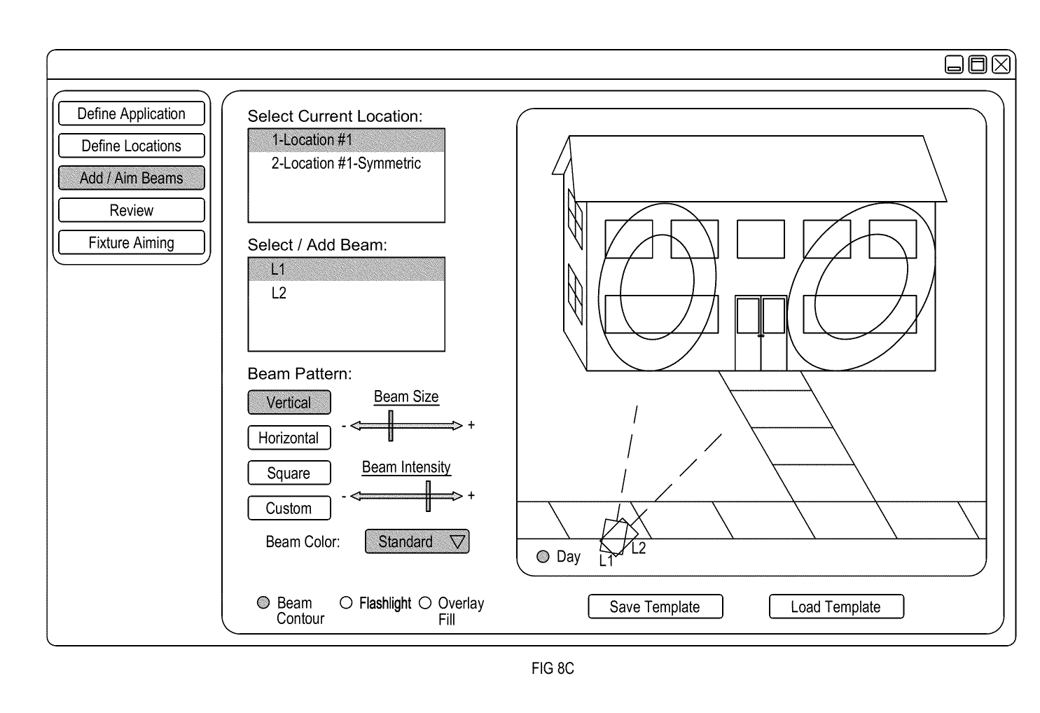

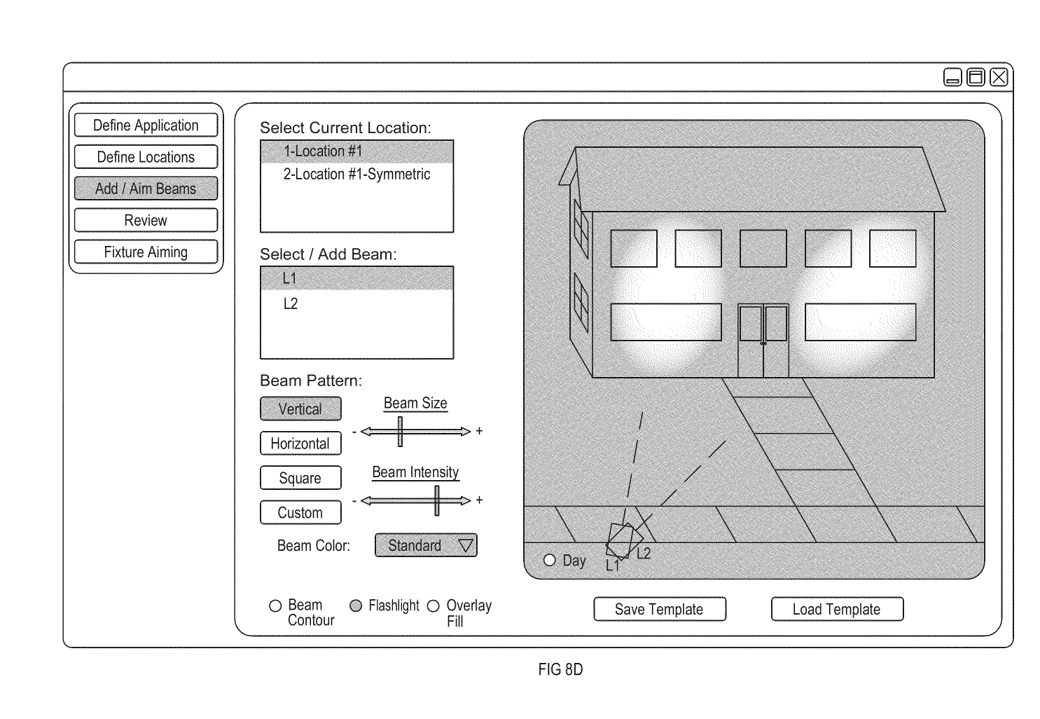

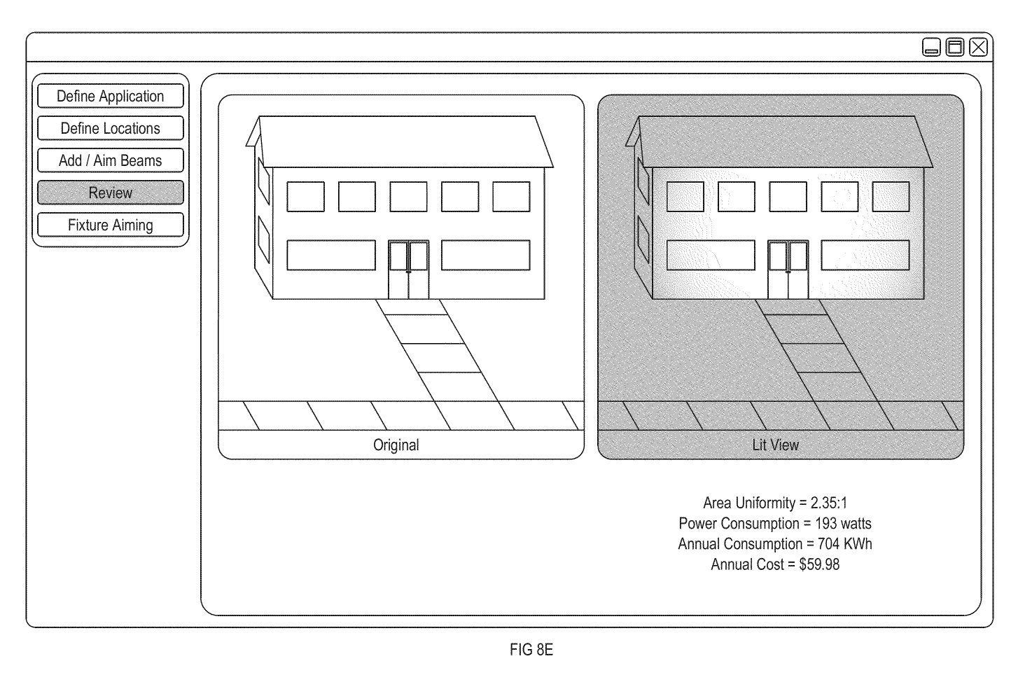

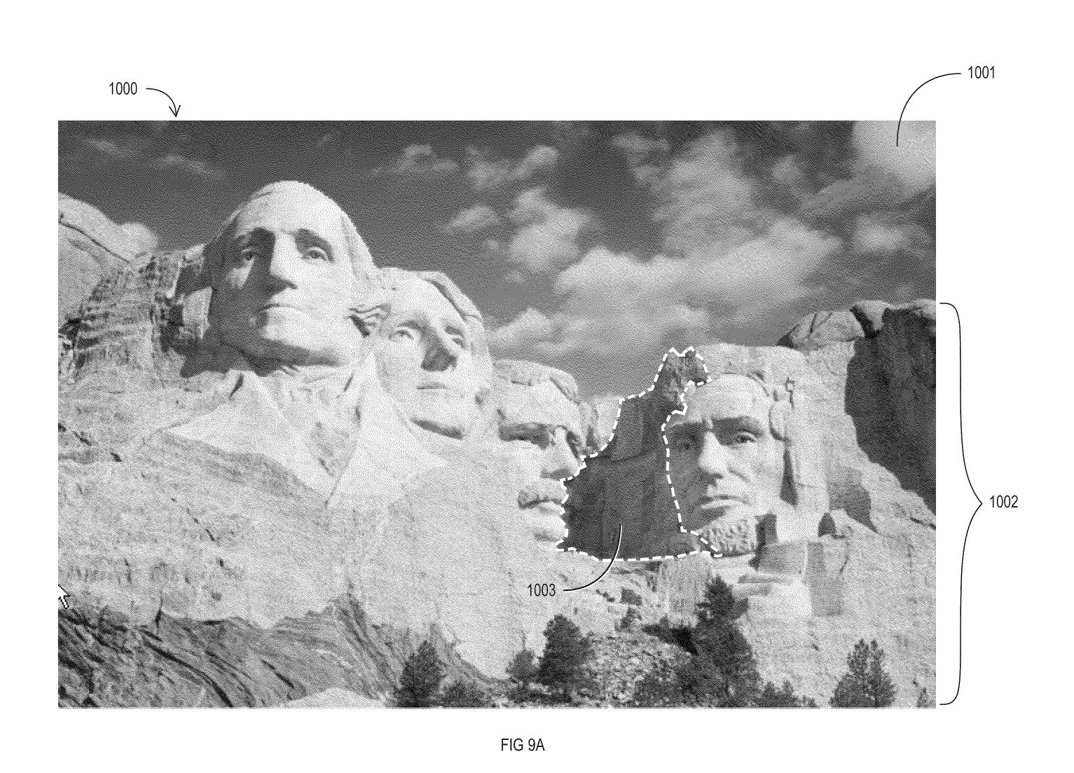

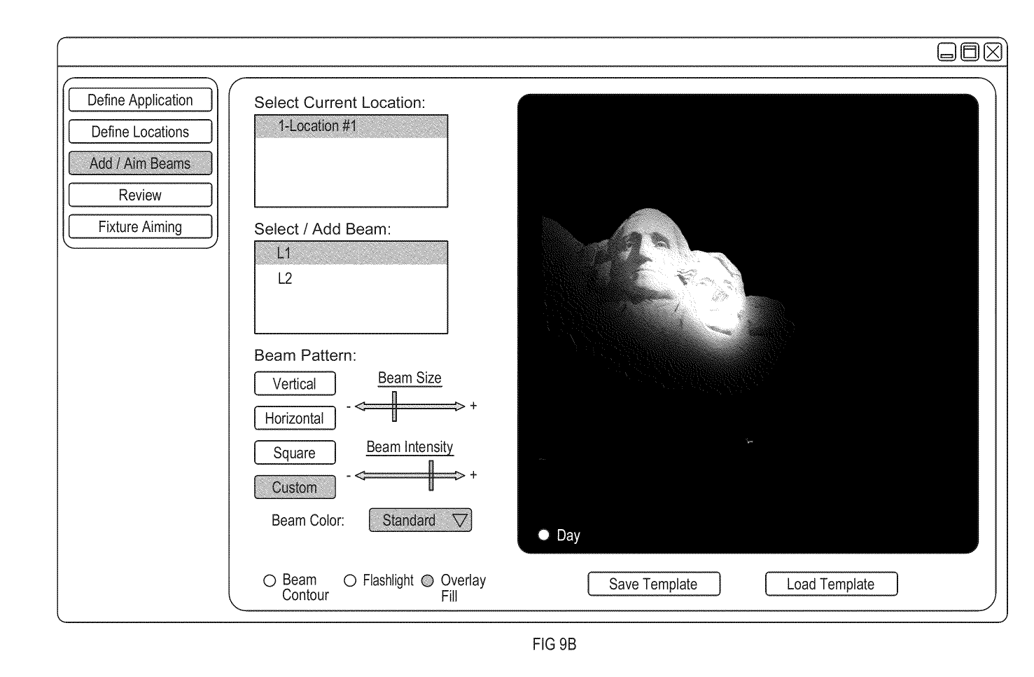

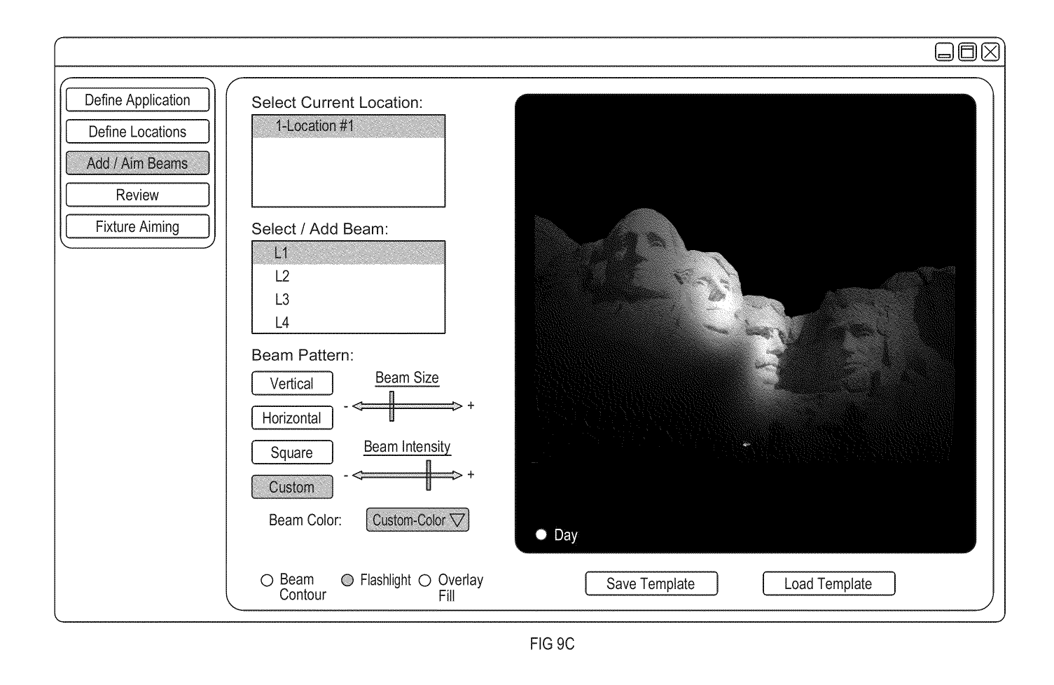

The precise way in which a target is rendered can vary according to need or desire. One example is computer modeling. Either an abstraction or graphical representative of the actual target (e.g., FIGS. 8A-E) or an actual image of the target (FIGS. 9A-C) could be obtained and displayed on a computer screen. By a number of ways know to those skilled in the art, lighting effects could be simulated on the displayed target and viewed. The simulated lighting scheme could also be adjusted on the computer and display to demonstrate different lighting effects or schemes. As indicated in FIGS. 8A-E and 9A-C, the computer could be programmed and have interfaces that would allow a user to control the simulated lighting in an analogous way to how an actual demonstration lighting system would be adjusted and controlled (like Embodiment 1). As illustrated in FIGS. 8A-E and 9A-C, the computer interface could adjust such things as number and type of virtual light fixtures, position and aiming of those virtual fixtures, intensity and beam, shape, size and type of the virtual fixtures color temperature and other light simulates. It could also adjust things such as amount and direction of day light, amount of ambient light, angle of view of the target, etc.

Additional details of the example of FIGS. 8A-E and 9A-C are set forth below. It is to be understood that a wide variety of alternatives and variations are possible.

Rendering an Image

As has been stated, one or more aiming locations are defined within the computer program relative to a defined point on the target or scene; each virtual aiming location correlates to a physical point in space relative to the actual target area from which actual lighting fixtures are to be aimed. From each of these virtual aiming locations any number of beam patterns may be selected for projection onto the scene. Following this, a user may move, resize, recolor, or otherwise manipulate a beam projection or a plurality of beam projections (e.g., the collective at an aiming location in unison) relative to the scene via a mouse (or analogous device) and selection tabs within the software program. The result is a rendered image of what the actual target area would look illuminated by an actual lighting system according to a defined lighting solution.

Once the image is rendered, the user or customer is able to compare the rendered image to the initial image (e.g., photograph). If desired, the user can render multiple images so to compare different lighting solutions. To make an accurate and efficient comparison, the scene is not recalculated as photometric projection patterns are removed, added, or manipulated, regardless of whether projected patterns are isocandela diagrams or lighting overlays. This allows the user to make changes and effectuate different lighting solutions in real time (e.g., the rendered view of the scene is updated in real time as the user re-aims beams via the cursor in the software program).

Further, because the human eye adapts to different light levels quickly, it is difficult to convey when one has added too many beams (i.e., exceeded a desired light level defined within the program). To address this concern, as additional photometric patterns are added, the software program adjusts the photometric patterns so to alter the overall tonal curve; the result is that areas illuminated to the desired level appear properly exposed and areas illuminated beyond the desired level appear over-exposed (e.g., see FIG. 9B). This provides the user with a visual cue as to when beams should be added or removed to produce a desired lighting solution.

Once the user or customer agrees upon a lighting solution, the software program can provide the information required to build an actual lighting system to produce the lighting solution in the software program (e.g., via exportable text file). Again, the level of detail will depend on how customized a system the supplier can or will provide and what variables are available for adjustment within the program. For example, a highly customized system might have documentation indicating the size and number of light source, type of optic, color gel, and aiming angle for each of a plurality of independently adjustable lighting modules, as well mounting height and aiming angle of an adjustable fixture housing which contains said modules, for the number of fixtures defined within the program (whether a fixture is defined as the object projecting a beam onto the scene from an aiming location or the collective of objects projecting beams at an aiming location).

A more specific example is illustrated in FIGS. 8A-E. The actual target area is a vertical surface, in this example the front face of a building.

As can be seen in the screenshot illustrated in FIG. 8A, the user has selected the appropriate application type and has chosen to upload an image of the target area. The user has chosen to treat the entire storefront as a single surface by defining only one lighting zone; the zone is defined in uploaded the image by boundary points (the four corners of the image). Zone 1 is further characterized in terms of reflectance and a desired light level.

Clicking the Define Locations tab in the software program brings up a new screen (see FIG. 8B) in which the user defines a number of aiming locations relative to one of the defined points on the target area in the image; in this example, two aiming locations (circled numerals 1 and 2 in FIG. 8B) are relative to the two lower boundary points of the image (see FIG. 8A). The image may be rotated or viewed from different angles (e.g., FIG. 8B) so that the user can visually ascertain where fixtures would be placed in an actual lighting installation.

Clicking on the Add/Aim Beams tab in the software program brings up a new screen (see FIGS. 8C and 8D) in which the user defines photometric projection patterns (i.e., beam patterns L1 and L2) according to pattern, size, intensity, and color; each beam pattern is associated with one of the defined aiming locations. FIG. 8C illustrates the projection of the isocandela diagram onto the scene (see user selections and image); note that for the sake of clarity, only the field angle and beam angle of the isocandela diagram is projected. Alternatively, FIG. 8D illustrates the projection of the lighting overlay (see different user selections) on the scene when dimmed to represent the target area at night. The user can aim and manipulate each beam contour (i.e., isocandela diagram) or flashlight (i.e., lighting overlay) via a mouse or analogous device. If desired, the user has the option of saving the collection of aimed beams and aiming locations as a template for use with other scenes.

Clicking on the Review tab in the software program brings up a new screen (see FIG. 8E) in which the user compares the target area as it appears during the day and as it would appear illuminated at night by a lighting system designed in accordance with the selections made on the previous screens. Additionally, a data field could display data useful to both lighting suppliers and a customer; for example, knowing the target illumination level (specified by the user in the software program), knowing the power consumption of the lighting system to achieve the target illumination level (the modules, luminaries, or fixtures specified by the user in the software program are of a known power consumption, or power consumption could be measured directly), and knowing the local electric rates (which can be input by the user), an operating cost may be calculated.

As has been described herein, a virtual target area may be defined by uploading an image such as a photograph, or building an image much like one would build a model. Methods of building or importing a model are well known in the art and so this process has not been described in great detail herein. Likewise, the process of taking and uploading an image is well known in the art and so this process has not been described in great detail herein. However, it is of note that if an image is uploaded to create the virtual target area the image could first be modified; image modification could be an optional feature of the envisioned software program or the image could be modified via a commercially available photo editing program. For example, FIG. 9A illustrates an image of a well-known landmark; as can be seen, the image is not ideal for use in the software program. One could modify image 1000 either in the software program or prior to uploading the image in the software program to black out area 1001 (which is not of interest) so to adequately represent a photograph taken at night (i.e., to aid in the effectiveness of dimming the scene). Shadow 1003 of area 1002 (which is of interest) could be addressed in a variety of manners; for example, prior to creating zones within the software program, area 1003 could be lightened. Alternatively, within the software the zone covering shadow 1003 could be given a different reflectance value so to reflect more light and appear brighter. Of course, the image could simply be taken at night; this may be preferable if a user wants to compare an existing lighting solution with what is possible, if the actual target area experiences some ambient light at night (e.g., spill light from an adjacent property), or to avoid undesirable shadowing, for example.

FIGS. 9B and 9C illustrate image 1000 as it may appear in the envisioned software program and illustrate two optional features of the envisioned software. FIG. 9B illustrates the software program in overlay fill mode; as previously described, in this mode as additional photometric patterns are added, the software program adjusts the photometric patterns so to alter the overall tonal curve. As can be seen from FIG. 9B, portions of image 1000 appear over-exposed and thus, give the visual cue that too many beams are aimed at a single point on the scene, the aimed beams are too intense, etc. FIG. 9C illustrates the use of color in the projected photometric patterns; the use of color is limited only to what a lighting supplier can or will provide. For example, if a lighting supplier wants to demonstrate to a user what is possible with sodium lamps, the selectable colors would likely be limited to yellowish hues. A wider range of colors may be available if the actual lighting fixtures comprise light emitting diodes, for example.

With further regard to optional features of the software program, in some situations developing a model is not preferable (e.g., due to time constraints) and so an image (e.g., from a camera) must suffice. However, if the object in the image has features with varying degrees of depth (e.g., compare area 1003 with the trees in the foreground of image 1000 in FIG. 9A), one way to quickly indicate such depth could be to create zones associated with each aiming location so to more accurately reflect what is physically possible. So for the example of image 1000, a zone for the foreground could be allocated to an aiming location near the foreground; this would ensure that zone 1003 of the virtual target area would not be illuminated by the virtual fixtures at the foreground aiming location because in the physical world light from the actual fixtures at the base of the image (Mt. Rushmore) aimed at the actual trees would not likely reach the shadowed space between presidents because of the actual setback. This optional approach allows a user to quickly indicate depth and demonstrate how aiming location affects the rendered image; however, it is preferable that for complex target areas such as that illustrated in FIG. 9A, a 3-D model be created within the envisioned software program or uploaded to the envisioned software program so that the rendered image more accurately reflects what is possible with an actual lighting system.

Of course, the software program could be adapted to print or export rendered images or documentation related to these steps.

Whether choosing a vertical lighting application or a horizontal lighting application, the software program is adapted to allow a user to customize the photometric projected patterns projected from a defined aiming location onto a defined scene. In the vertical lighting application this is achieved by selecting one or more beam patterns, each pattern being variable in size, shape, color, intensity, and aiming angle, for example. In the horizontal lighting application this is achieved by selecting one or more layout types, beam patterns, and uniformity levels, for example. There are many benefits to separating customization options according to the selected application type. For example, vertical lighting is typically an artistic process; a customer is generally more concerned with the aesthetic of a storefront than actual light levels. Thus, for vertical lighting, it is important to include many non-standard options (e.g., colored lighting, custom beam shapes) so to maximize flexibility in creating a lighting solution. Alternatively, horizontal lighting is typically a utilitarian process; a customer is generally more concerned with getting a parking lot lit to acceptable levels with a minimum number of fixtures than with the aesthetic feel the lighting evokes. Thus, for horizontal lighting, it is important to include standard options (e.g., fixed aiming angles, symmetric spacing of fixtures) so to maximize efficiency in creating a lighting solution. It is of note, however, that the software program could omit the selection of application type and make all customization choices available to the user regardless of what the user wanted to illuminate. Alternatively, there could still be a selection of application type but with different customization options than those illustrated and described herein.

There are also other benefits to separating customization options. For example, the software program could be adapted to accommodate users of varying degrees of proficiency in lighting design. For example, if the user was a customer who has never designed a lighting system, the software program could offer many application types (possibly with an icon or other visual indication of what is included in that type) with a limited number of customization options within each type (e.g., only aiming angle and beam type). Alternatively, if the user is a lighting supplier, the software program could offer a wide range of customization options with no separate choice for application type.

Ultimately, aspects according to the present invention help a user to visualize how a target area might look with a particular lighting solution without having to set up the actual lighting equipment to demonstrate said solution. However, aspects according to the present invention do not prevent a lighting supplier (whether associated with the envisioned software, a competitor of the lighting supplier associated with the envisioned software, or otherwise) from also demonstrating said solution. In practice, the documentation produced from apparatus, methods, and systems described herein (e.g., rendered images, information for building an actual lighting system, lighting scans, etc.) could be used as a project specification such that lighting suppliers must demonstrate their ability to meet the specification to be considered by the user for purchase of the actual lighting system.

### F. Options and Alternatives

The invention may take many forms and embodiments. The foregoing examples are but a few of those. To give some sense of some options and alternatives, a few examples are given below.

As described herein, the target area comprises a building, parking lot, and a walkway connecting the two; this is by way of example and not by way of limitation. For example, the target area may be a sports field or the interior of a hallway. Other substantially large area targets are applicable. As another example, the target area may have existing lighting that provider 3 must take into account when demonstrating lighting solutions 4 and documenting the approved lighting scheme.

As described herein, a provider 3 uses a computer or analogous device to document and record lighting preferences described by customer 1, as well as to characterize the lighting scheme approved of by customer 1; this is by way of example and not by way of limitation. As an alternative to a computer or analogous device, a provider 3 may record lighting preferences on paper and supplement written documents with photographs of the target area when illuminated using the desired lighting scheme. Any systems, apparatus, or methods by which provider 3 is able to translate customer 1 expressed lighting needs into quantifiable lighting parameters—with the purpose of providing customer 1 with a tangible product to provide to potential suppliers 6—may be used and not depart from at least some aspects of the present invention. Alternatively, a computer or analogous device may be used, but web page 20 may look significantly different than that illustrated in FIG. 3, or may have different information tabs. As another example, web page printout 30 may look different from that illustrated in FIG. 4.

As described herein, potential suppliers 6 provide a visual demonstration as means of demonstrating a lighting solution 7; this may be facilitated by any of the systems, apparatus or methods described herein. Alternatively, potential suppliers 6 may use a different method deemed acceptable by customer 1 (e.g., providing photometric data which can be correlated to that on printout 30). Regardless of the system or method used by potential suppliers 6, it may be preferable for customer 1 to request an independent lighting group evaluate the permanent lighting system after installation is complete to verify customer 1 lighting needs have been met.

Lighting demonstration systems may differ from those described herein. For example, a lighting demonstration system may use wall mounted sconce-type fixtures if illuminating an interior hallway. As another example, a lighting demonstration system may operate on existing site power, thus omitting power providing device 8. Other systems are possible.

As another option, initial provider 3 may be considered as a potential supplier 6 of a permanent lighting system, with the exception that provider 3 need not demonstrate a lighting solution at step 7 of the process illustrated in FIG. 1. For example, if initial provider 3 demonstrates a lighting solution according to step 4 of the process illustrated in FIG. 1, customer 1 agrees upon the lighting scheme, and provider 3 provides customer 1 with adequate information (e.g., cost, lead time)—which can be listed on web page 20 or printout 30, but is not required to be—provider 3 need not perform a second round of demonstrations to be considered for the permanent lighting system.

Variations obvious to those skilled in the art are included with these exemplary embodiments.

What is claimed is:

1. A method of providing customer-defined lighting to a target area comprising:
a. performing by an initial provider a lighting demonstration in the presence of a customer using a lighting demonstration system;
b. evaluating the lighting demonstration by the customer;
c. adjusting the lighting demonstration system per the customer evaluation until the customer confirms a desired result;
d. developing a lighting performance specification according to the desired result; and
e. evaluating potential permanent lighting systems according to their ability to produce the desired result.

2. The method of claim 1 wherein:
a. the customer comprises an owner of, user of, or person(s) responsible for the target area and/or permanent lighting system; and
b. the initial provider is a lighting designer, lighting supplier, lighting manufacturer, lighting association, or person(s) associated with the lighting industry.

3. The method of claim 2 further comprising verifying the ability of a potential permanent lighting system to reproduce the desired result by an independent party.

4. The method of claim 1 wherein the lighting demonstration system is mobile.

5. The method of claim 1 wherein the lighting demonstration system is a scaled version of a larger lighting demonstration system or permanent lighting system.

6. The method of claim 1 wherein the lighting demonstration system includes a computer with software adapted to render an image of the target area.

7. The method of claim 6 wherein the lighting demonstration includes modification of the rendered image of the target area.

8. The method of claim 1 wherein step (a) is completed at or near the target area.

9. The method of claim 1 wherein the adjustment of the lighting demonstration system comprises one or more of:
a. adding an optical element;
b. removing an optical element;
c. positioning an optical element; and
d. replacing an optical element with one or more other optical elements;
e. the optical element comprising one or more of:
i. a lens;
ii. a diffuser;
iii. a visor;
iv. a color gel; and
v. a light source.

10. The method of claim 1 wherein the adjustment of the lighting demonstration system further comprises adjusting input power to one or more light sources.

11. The method of claim 1 wherein the lighting demonstration system comprises a plurality of lighting components and the adjustment of the lighting demonstration system further comprises adjusting the position of one or more of the lighting components of the lighting demonstration system relative the target area.

12. The method of claim 1 wherein the lighting performance specification comprises photometric data.

13. The method of claim 1 wherein the lighting performance specification further comprises a graphical representation of the target area.

14. The method of claim 1 wherein the evaluation of potential permanent lighting systems is based, at least in part, on potential lighting suppliers performing lighting demonstrations at the target area using the lighting performance specification as guidance.

15. The method of claim 14 wherein the potential lighting suppliers are lighting designers, lighting suppliers, lighting manufacturers, lighting associations, the provider, or person(s) associated with the lighting industry.

16. The method of claim 15 wherein one of the potential lighting suppliers is the initial provider and wherein the initial provider is not required to produce the desired result according to step (e).

17. A method of large area lighting comprising:
a. deriving a preliminary lighting scheme for a large area in consultation with a customer related to the large area;
b. providing to the customer a first demonstration lighting scheme of the large area based on the preliminary lighting scheme from the customer;
c. obtaining a customer-approved lighting scheme for the large area by:
i. approval by the customer of the first demonstration lighting scheme; or
ii. approval by the customer of an adjusted demonstration lighting scheme provided by adjusting the first demonstration lighting scheme;
d. converting the customer-approved lighting scheme to a customer-approved quantitative lighting specification.

18. The method of claim 1 wherein the first demonstration lighting scheme is providing by one of:
a. a portable, temporary, adjustable lighting system;
b. a portable, temporary lighting system;
c. a reduced-in-scale temporary lighting system;
d. a computer rendering.

19. The method of claim 1 further comprising requesting from one or more potential suppliers of permanent lighting systems a demonstration that a permanent lighting system will meet the customer-approved quantitative lighting specification for the large area.

20. The method of claim 3 further comprising selecting and installing a permanent lighting system from a supplier.

21. The method of claim 1 wherein the customer-approved quantitative lighting specification comprises one or more of the following lighting fixture parameters:
a. color temperature;
b. operating wattage;
c. field angle(s);
d. luminous efficacy;
e. coefficient of utilization;
f. type;
g. number;
h. placement;
i. elevation;
j. light intensity;
k. light intensity uniformity.

22. A system for selecting large area lighting comprising:
a. an apparatus to demonstrate a plurality of possible lighting schemes for a large area to a customer;
b. a computer with memory storage media and software to store data regarding:
i. the customer,
ii. the large area,
iii. the lighting schemes;
iv. display a summary of any of the lighting schemes;
v. document a lighting scheme selected from one of the possible lighting schemes.

23. The system of claim 6 wherein the apparatus comprises one of:
a. a portable, temporary, adjustable lighting system;
b. a portable, temporary lighting system;
c. a reduced-in-scale temporary lighting system;
d. a computer rendering.

24. The system of claim 6 further comprising producing a customer-approved lighting specification from the document.

25. The system of claim 8 further comprising a permanent lighting system installed at the large area based on the customer-approved lighting specification.
